(19) United States
(12) Patent Application Publication
(10) Pub. No.: US 2012/0121853 A1
(43) Pub. Date: May 17, 2012

(54) REINFORCED INJECTION MOLDED THERMOPLASTIC CELLULAR CORE

(76) Inventors: Stephen L. Mendola, Pittsford, NY (US); Rainer Duchene, Natick, MA (US)

(21) Appl. No.: 12/918,653

(22) PCT Filed: Jul. 29, 2010
(86) PCT No.: PCT/US10/43672

§ 371 Date: Aug. 20, 2010

Related U.S. Application Data
(63) Continuation-in-part of application No. 12/462,669, filed on Aug. 7, 2009, now abandoned.

(51) Int. Cl. B32B 3/12

(52) U.S. Cl. 428/116

(57) ABSTRACT

A reinforced, thermoplastic, injection molded cellular core is provided, wherein the cellular core can include minimum wall thickness sections of less than 1.5 mm and in selected constructions less than 0.5 mm, wherein larger reinforcing pillars at disposed at predetermined locations to form a structural body. A cross sectional shape, sizing and spacing of a plurality of cells within the cellular core can be set in a predetermined configuration to provide for varying density of the cellular core. Reinforcing elements can be uniformly or non-uniformly distributed throughout the cellular core. Stratum can be integrally formed with the cellular core to provide additional performance characteristics.

### CROSS-REFERENCE TO RELATED APPLICATIONS

The present application is a national stage filing of PCT Patent Application No. PCT/US10/43672 filed Jul. 29, 2010, which claims priority to U.S. patent application Ser. No. 12/462,669 filed Aug. 7, 2009. Each of these priority applications is hereby expressly incorporated by reference.

### STATEMENT REGARDING FEDERALLY SPONSORED RESEARCH OR DEVELOPMENT

Not Applicable.

### REFERENCE TO A “SEQUENCE LISTING”

Not applicable.

### TECHNICAL FIELD

The present invention generally relates to an injection molded cellular core, such as a honeycomb, and a method for injection molding the cellular core, wherein reinforcing elements, stratum and varying geometries can be imparted to reinforce the cellular core.

### BACKGROUND ART

Polymeric honeycombs have been available for nearly 40 years. These honeycombs typically are used as a structural material within sandwich panels or as a substrate to hold together a matrix of a different material. These honeycombs typically are produced through an extrusion process or by folding and/or welding together films.

However, the extrusion and folding/welding processes significantly limit the shape of the cells within the honeycombs, the shape and construction of the structural spaces between the cells, and the range of polymer materials that comprise the cell walls. Additionally, the extrusion and folding/welding processes require dedicated, highly-specialized production equipment and largely preclude both the addition of flowable reinforcing elements to the polymer, and the manufacturing of reinforcing structures integrated within the honeycomb, all in a single production process. For product applications requiring the honeycombs have higher mechanical properties than can be achieved with existing structures, additional manufacturing processes, materials, and costs are required to enhance the structural properties of the honeycomb.

Given current honeycombs are manufactured via an extrusion or similar process, the addition of reinforcing elements into the polymer material is not available. In addition, as current honeycombs are manufactured via an extrusion or similar process, the integration of a reinforcing stratum into the honeycomb is not feasible within such processes.

Therefore, the need exists for a cellular core that can be configured to incorporate reinforcing elements, stratum or reinforcing structures (such as pillars) within the cellular core. The need also exists for a method of manufacturing such a cellular core.

### DISCLOSURE OF INVENTION

The present disclosure provides a polymeric cellular core that overcomes many of the structural limitations and economic inefficiencies of existing polymeric cellular cores. By utilizing injection molding methods, machines, and processes, the present system offers new levels of mechanical properties and degrees of design and engineering freedom not available with existing cellular cores and at a lower cost than alternatives currently available. The benefits of the present system result in higher mechanical properties at a lower weight and at a lower cost than is achievable with existing core materials.

The present cellular core provides a light-weight, high-strength cellular core material out of thermoplastic polymers or thermoplastic elastomers, which for purposes of this description are referred to interchangeably as “polymers” or “polymeric materials”.

The present system provides for a cellular core assembly having a polymeric core body having a plurality of cells defined by cell walls, the cell walls having a plurality of minimum wall thickness sections and reinforcing pillars, each reinforcing pillar bounded by at least three minimum wall thickness sections; and a minimum wall thickness section being less than 1.5 mm and a centroid of the reinforcing pillar spaced from the nearest cell by a distance greater than the minimum wall thickness.

It is contemplated the cells of the cellular core assembly can have any of a circular cross section; a polygonal cross section; a curvilinear cross section; a cross section at least partially defined by a facet or any combination thereof. In one configuration, the minimum wall thickness sections have a dimension of less than 1.0 mm.

In a further configuration, the cellular core can include a second different minimum wall thickness section in addition to a first minimum wall thickness section. In the cellular core, the reinforcing pillar can be bounded by at least one of the first and second minimum wall thickness sections. It is further contemplated the reinforcing pillar can have a cross-sectional area greater than the cross sectional area of an adjacent cell. In an additional configuration, the cell walls can define an integral peripheral wall extending about the core body, wherein the peripheral wall has a thickness less than the minimum wall thickness section.

A further configuration of the cellular core assembly includes a polymeric core body having a plurality of cells defined by cell walls, the cell walls having minimum wall thickness sections and reinforcing pillars, each reinforcing pillar bounded by at least three minimum wall thickness sections; and a plurality of reinforcing elements within the core body.

In selected configurations, the reinforcing elements can be fibers, spheres or interlaced elements.

It is further contemplated the cellular core assembly can include a polymeric core body having (i) a plurality of cells defined by cell walls, the cell walls having minimum wall thickness sections and reinforcing pillars, each reinforcing pillar bounded by at least three minimum wall thickness sections; and (ii) a stratum occluding the plurality of cells, the stratum being integral with the cell walls.

The present system also provides for a method of forming a cellular core assembly by injection molding a polymeric material to form a core body having a plurality of cells defined by cell walls, the cell walls having minimum wall thickness sections and reinforcing pillars, each reinforcing pillar bonded by at least three minimum wall thickness sections, the minimum wall thickness sections being less than 1.5 mm.

It is contemplated the method can include injection molding a stratum with the core body; incorporating a plurality of reinforcing elements in the injection molded polymeric material; forming the core body to have a substantially uniform density or forming the core body to have a non-uniform density.

A method is also disclosed for forming a cellular core assembly by injection molding a polymeric material to form a core body having a plurality of cells defined by cell walls, the cell walls having minimum wall thickness sections and reinforcing pillars, each reinforcing pillar bounded by at least three minimum wall thickness sections, the polymeric material including a plurality of reinforcing elements.

The method can further include any of forming the minimum wall thickness sections to be less than 1.5 mm; forming the minimum wall thickness sections to be less than 1.0 mm; forming the minimum wall thickness sections to be less than 0.5 mm; or injection molding a stratum with the core body.

A further method is provided for forming a cellular core assembly by (a) injection molding a polymeric material to form a core body having (i) a plurality of cells defined by cell walls, the cell walls having minimum wall thickness sections and reinforcing pillars, each reinforcing pillar bounded by at least three minimum wall thickness sections, and (ii) a stratum occluding the plurality of cells.

The method can further include any of injection molding the stratum transverse to the cell walls; injection molding the stratum inclined relative to the cell walls; injection molding the stratum along a first edge of the cell walls; injection molding the stratum intermediate a first edge and a second edge of the cell walls; injection molding the cell walls of a first material and the stratum of a different second material; or injection molding the cell walls and the stratum of the same material.

### BRIEF DESCRIPTION OF DRAWINGS

FIG. 1 is a perspective view with a partial cut away of an injection molded cellular core.

FIG. 2 is a side elevation view of an injection molded cellular core showing a varying height of the cellular core.

FIG. 3 is a top plan view of an alternative configuration of an injection molded cellular core.

FIG. 4 is a top plan view of a further configuration of an injection molded cellular core.

FIG. 5 is a top plan view of another configuration of an injection molded cellular core.

FIG. 6 is a top plan view of another alternative configuration of an injection molded cellular core.

FIG. 7 is a top plan view of yet another alternative configuration of an injection molded cellular core showing a uniform distribution of reinforcing elements.

FIG. 8 is a top plan view of a configuration of an injection molded cellular core showing a non-uniform distribution of reinforcing elements.

FIG. 9 is a side elevational view of a stratum in a first configuration within the cellular core.

FIG. 10 is a side elevational view of a stratum in a second configuration within the cellular core.

FIG. 11 is a side elevational view of a stratum in a third configuration within the cellular core.

FIG. 12 is a representative injection molding configuration for forming the cellular core, showing a portion of the mold in detail.

### BEST MODE(S) FOR CARRYING OUT THE INVENTION

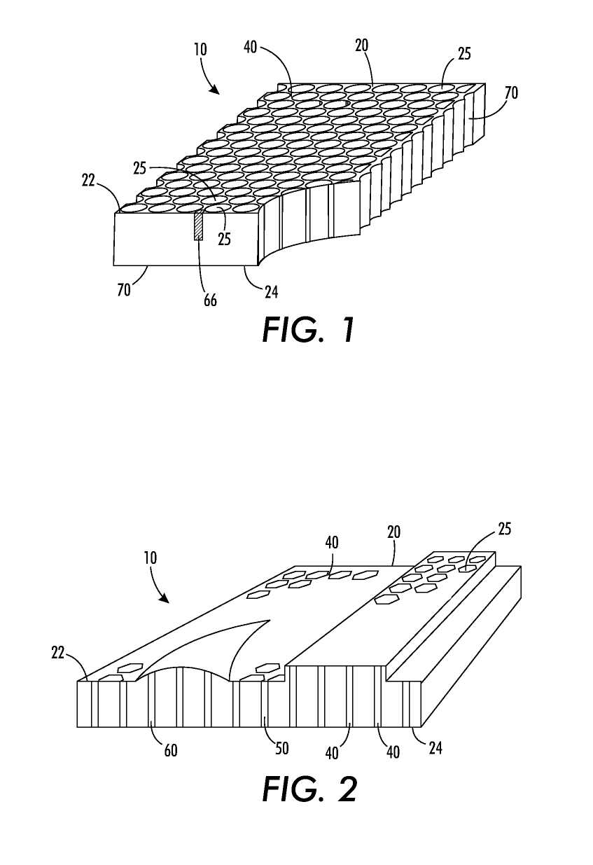

Referring to FIGS. 1 and 2, a cellular core 10 includes a core body 20 having a plurality of cells 25 defined by cell walls 40. The core body 20 has a first edge 22 and a second edge 24. For purposes of description, the core body 20 has a height defined by the first edge 22 and the second edge 24.

As seen in FIG. 1, in one configuration, the first edge 22 and the second edge 24 are substantially planar and parallel. However, it is understood the first and the second edge can be inclined relative to each other. In a further configuration seen in FIG. 2, one or both of the edges 22, 24 can define a generally curvilinear or faceted “surface” in which case the first edge 22 and the second edge 24 are not substantially planar and parallel.

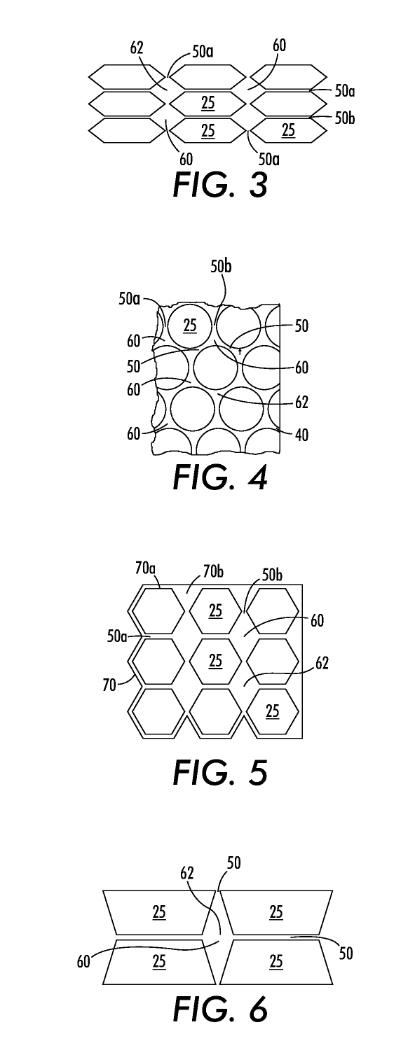

Referring to FIGS. 3-8, the cell walls 40 have a plurality of minimum wall thickness sections 50 and a plurality of reinforcing pillars 60. The minimum wall thickness section 50 is that section of the cell wall 40 intermediate a first cell 25 and the nearest cell 25 at the point of minimum separation of the two cells, and is thus the minimum distance between the two adjacent cells. For a uniform cellular core 10, as shown in FIGS. 1 and 2, the cell walls 40 will have a single minimum wall thickness section 50 that is consistent throughout the core body 20. However, as seen in FIGS. 3, 4 and 5, it is contemplated that the core body 20 can be constructed such that the cell walls 40 define a first minimum wall thickness section 50a and a second minimum wall thickness section 50b. That is, the minimum distance between the nearest cell 25 can be different from the minimum distance to the next nearest cell 25. Alternatively, a first portion of the core body 20 may have a first minimum wall thickness section 50a and a second of the core body can have a different second minimum wall thickness section 50b. Thus, the cell walls 40 may define a first minimum wall thickness section 50a and a different second minimum wall thickness section 50b. For purposes of description the term minimum wall thickness section 50 is used, with the understanding that the minimum wall thickness section 50 can include at least two or more different minimum wall thickness sections.

Each reinforcing pillar 60 is bounded by at least three minimum wall thickness sections 50. However, depending upon the particular shape of the cells 25, the reinforcing pillar 60 can be bounded by more than three minimum wall thickness sections 50.

As the core body 20 can have a single size, consistent sized, minimum wall thickness sections or two or more sized minimum wall thickness sections 50a, 50b, depending on the sizing and geometry of the cells 25, there may be a plurality of minimum wall thickness sections that bound a given reinforcing pillar 60. Thus, a given reinforcing pillar 60 can be bounded by at least one of the first and second minimum wall thickness sections 50a and 50b.

The cells 25 of the cellular core 10 can be distributed in a uniform or non-uniform pattern throughout the core body 20. That is, the number of cells 25 per unit area can vary across the core body 20, such as by varying the size or shape of the cells, as well as the size and shape of the cell walls 40. The cells 25 can be all of the same size, resulting in the cellular core 10 having a uniform density throughout the core body 20. Alternatively, the cells 25 can be of various sizes, resulting in the cellular core 10 having a non-uniform density throughout the core body 20. As seen in FIGS. 3-8, the cross section of the cells 25 can be of any geometric shape, including, polygonal, faceted, circular, or curvilinear. The cells 25 can also have a cross section defined by a combination of shapes such that portion of the cell is defined by a curvilinear length and a portion is defined by a straight length.

The cells 25 have an internal, cross-sectional dimension (measured as a diagonal for polygonal cell shapes or as a diameter for circular or oval cell shapes) that is between 3 mm and 30 mm and a cell depth that is between 5 mm and 200 mm.

In order to achieve the high mechanical strength aspect of the cellular core 10, the cell walls 40 define the reinforcing pillar 60 as a component of the geometry of the cellular core. Each reinforcing pillar 60 is bounded by at least 3 minimum wall thickness sections 50. As seen in FIGS. 3-8, the reinforcing pillars 60 within the core body 20 can be any of a variety of shapes and patterns, depending on the intended operating parameters of the cellular core.

Each reinforcing pillar 60 has a centroid 62 (geometric center or barycenter), the point in the cross sectional plane of the reinforcing pillar that is the intersection of all straight lines that divide the reinforcing pillar into two parts of equal moment about the line. Informally, the centroid 62 is the “average” (arithmetic mean) of all points of the cross sectional area of the reinforcing pillar 60.

In selected configurations, as seen in FIG. 3, the distance between the centroid 62 of the reinforcing pillar 60 and the edge of the closest cell 25 is greater than the dimension of the minimum wall thickness section 50. The reinforcing pillar 60 increases the mechanical strength of the cellular core 10 both by reinforcing the cellular core itself as well as providing additional surface area to which other materials (e.g., a superficial skin or other material component) can be attached such as by bonding (via an adhesive) or fusing (via melting and pressing or welding, including ultrasonic welding). In selected configurations, the area of a cross section of the reinforcing pillar 60 can be greater than the cross sectional area of an adjacent cell 25.

The shapes and sizes of the cells 25, cell walls 40, and reinforcing pillars 60 can vary between different local regions within a single core body 20 in order to provide different desired properties within the different local regions. That is, as core body 20 is formed by injection molding, the cellular core 10 can have different constructions within a given core, thereby providing axis or plane of preferential performance.

The cellular core 10 can be formed from thermoplastic polymers or thermoplastic elastomers. Satisfactory thermoplastic polymers include: Acrylonite-Butadiene-Styrene Terpolymer (ABS), Polymethyl Methacrylate Acrylic (Acrylic/PMMA), High Temperature Nylon (HTN), Liquid Crystal Polymers (LCP), Polyamide (PA/Nylon), Polybutylene Terephthalate (PBT), Polycarbonate (PC), Polyethylene (PE), Polyetherether Ketone (PEEK), Polyetherimide (PEI), Polyetherketoneketone (PEKK), Polyethylene Terephthalate (PET), Polyethlene Terephtalate Glycol (PETG), Polypropylene (PP), Polyphenylene Sulfide (PPS), Polystyrene (PS), and Polysulfone (PSU). Satisfactory thermoplastic elastomers include: Thermoplastic Polyurethane (TPU), Polyolefin Thermoplastic Elastomer (TPO). Again for purposes of this description these thermoplastic polymers and thermoplastics elastomers are referred to as “polymers” or “polymeric materials”.

For a number of the intended applications, the density of the cellular core 10 should be as low as possible. This density is the weight of the cellular core 10 divided by the volume defined by the outside dimensions of the core. Thus, a density different from the density of the polymeric material forming the cellular core 10 is determined. A typical density range for the cellular core 10 can be between 4 lbs/ft³ (64 kg/m³) and 12 lbs/ft³ (192 kg/m³).

For cellular cores 10 having the following general configuration, the cores have the performance parameters as set forth below:

| | Core | Compressive | Shear | Shear |
|---|---|---|---|---|
| | Density | Strength | Strength | Modulus |
| Core Type | kg/m³ | Mpa | Mpa | Mpa |
| TriCore 9.0-140 GF | 140 | 13 | | |
| TriCore 9.0-140 | 140 | 11.00 | 3.60 | 65 |

As set forth above, the 9.0 is the cell diameter in mm, and the 140 is the density of the cellular core 10, prior to inclusion of reinforcing elements.

In one configuration, the dimension of the minimum wall thickness section 50 is less than 1.5 mm, in selected configurations less than 1.0 mm and in further configurations less than 0.5 mm.

In contrast to current core materials and manufacturing methods which require the addition of structural materials or components to a honeycomb after the honeycomb has been produced in a prior production step, the desired low density and high mechanical strength parameters can be achieved by the geometry (including cell shape, dimensioning of the minimum wall thickness sections 50 and the reinforcing pillars 60) of the cellular core 10 in the present single production step/process.

The cell walls 40 can be shaped to enhance reinforcement of the cellular core 10. Specifically, the shape and size of the reinforcing pillar 60 and minimum wall thickness sections 50 can be shaped for reinforcement of the cellular core 10.

Referring to FIG. 1, it is also contemplated that at least selected reinforcing pillars 60 can be sized to incorporate a separate component 66 (e.g., a fastener, hinge, post or fixture) made of a material different than the polymer of the cellular core 10, wherein the separate component 66 can be partially or completely embedded within the cell walls 40, such as in selected reinforcing pillars 60 at the same time the cellular core 10 is formed. As set forth in further detail, the incorporation of the separate component 66 provides for the production of a subassembly with value-added components that to date have required additional production steps and costs when working with current honeycomb materials and fabrication.

Referring to FIGS. 1 and 2, a perimeter 70 of the core body 20 is formed by the cell walls 40 at the edge of the core body 20. For example, when no more than two cells 25 abut one another, the cell walls 40 define the integral peripheral wall 70 extending about the core body 20. The thickness of the cell walls 40 forming the peripheral wall 70 will depend on the intended use of the cellular core 10. In some cases the peripheral wall 70 thickness may be less than the dimension of the minimum wall thickness section 50. In alternative constructions, the thickness of the peripheral wall 70 may be equal to, or greater than, the dimension of the minimum wall thickness section 50. Referring to FIG. 5, it is also contemplated the thickness of the peripheral wall 70 can be of variable thicknesses 70a and 70b in order to form a flat, planar surface around part, or all, of the outer peripheral surface of the core body 20.

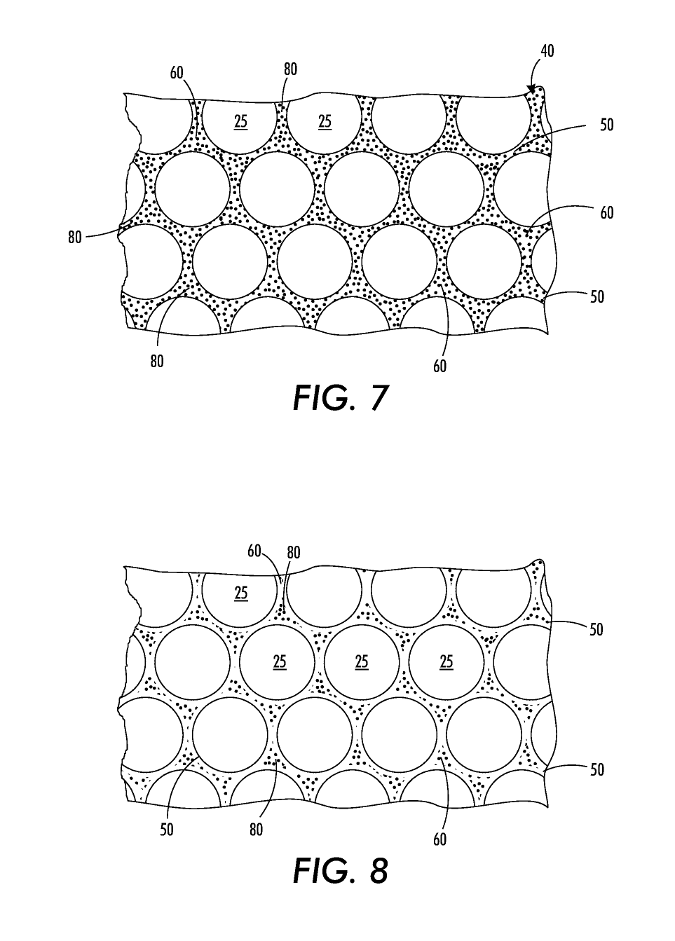

Referring to FIGS. 7 and 8, another aspect of the present cellular core 10 that can increase the mechanical strength of the cellular core 10 includes the optional addition of reinforcing elements 80 incorporated into the polymer forming the cellular core 10. The present use of an injection molding process provides for a wide range of reinforcing elements 80 to be added to the polymer prior to the production of the cellular core 10. These reinforcing elements 80 can include fibers made of glass, carbon, aromatic polyamide (aramid), or natural materials, or spheres made of glass, or other material.

The use of fibers as the reinforcing elements 80 are generally of a size that is between 1 μm and 100 μm in diameter and 10 μm and 2000 μm in length. Typically, the reinforcing element 80 is incorporated into the polymer in a production process that is completed prior to the making of the cellular core 10. The combination of the polymer and the reinforcing elements 80 creates a composite material yielding the mechanical benefits of such. For example, for a given configuration of the cellular core 10, when comparing a sample formed without reinforcing elements 80 to a sample formed with reinforcing elements 80 (such as 10% by weight glass fibers), the added reinforcing elements increased the compressive strength by 20%. The shear strength and modulus were also increased due to the presence of the reinforcing elements, but the new values exceeded available testing equipment.

The reinforcing elements 80 can have a uniform or a non-uniform distribution within the cellular core 10, between the relatively larger portions of the cellular body defined by the reinforcing pillars 60 and the minimum wall thickness sections 50. The distribution of the reinforcing elements 80 within the cellular core 10 is determined primarily by the relative dimensions of the reinforcing elements 80, the reinforcing pillars 60, and the minimum wall thickness sections 50. As the minimum wall thickness sections 50 are of relatively smaller dimensions than the reinforcing pillars 60, the reinforcing elements 80 will tend to be distributed in a relatively lower density in the minimum wall thickness sections 50 and relatively higher density in the reinforcing pillars 60. The desired distribution pattern of the reinforcing elements 80 within the cellular core 10 can be achieved by selecting reinforcing elements of such dimensions that either inhibit or promote the distribution of the reinforcing elements throughout the core body 20 during the injection molding process.

Referring to FIG. 7, to achieve a more uniform distribution of the reinforcing elements 80 throughout the cellular core 10, the difference in dimensional size between the reinforcing pillars 60 and the minimal wall thickness sections 50 should be minimized at the same time that the dimensional size of the reinforcing elements 80 should be minimized.

Referring to FIG. 8, to achieve a more non-uniform distribution of the reinforcing elements 80 throughout the cellular core 10, the difference between the dimensional size of the reinforcing pillars 60 and the minimum wall thickness sections 50 should be maximized, as the difference between the dimensional size of the reinforcing elements 80 and the minimum wall thickness sections 50 should be minimized.

The distribution of the reinforcing elements 80 within the cellular core 10 can range from substantially homogenous (i.e., within 5% difference in distribution between the minimum wall thickness sections 50 and the reinforcing pillars 60) as shown in FIG. 7, to nearly all (i.e., greater than 90%) of the reinforcing elements 80 being within the reinforcing pillars 60 as shown in FIG. 8.

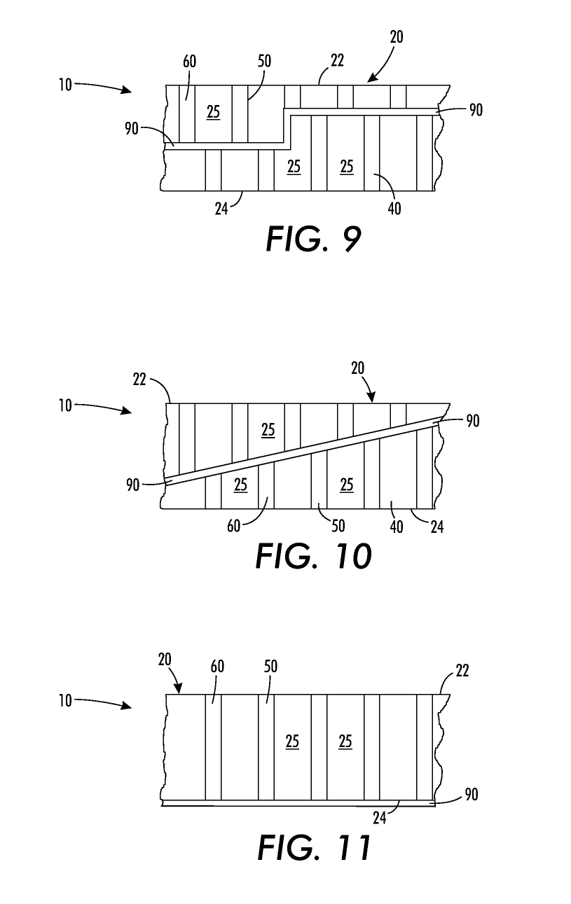

Referring to FIGS. 9, 10, and 11, another aspect of the cellular core 10 that can substantially increase the mechanical strength of the cellular core includes the optional integration of at least one reinforcing stratum 90 within the cellular core. The reinforcing stratum 90 can be planar, substantially planar, curvilinear or faceted. It is further understood the stratum 90 can partially or completely occlude some or all of the cells 25 within the core body 20. Since the cellular core 10 is made by injection molding, a wide range of strata 90 can be incorporated into the cellular core during formation of the core body 20.

The reinforcing stratum 90 can be incorporated into the structure of the cellular core 10 such that the stratum is transverse to the cell walls 40, as seen in FIG. 9. It is further contemplated that the reinforcing stratum 90 can be incorporated into the core body 20 such that the stratum is intermediate the first and second edge of the core body, as depicted in FIGS. 9 and 10. Alternatively, the reinforcing stratum 90 can be incorporated into the cellular core body 20 such that the stratum is inclined relative to the cell walls, as seen in FIG. 10. Referring to FIG. 11, the stratum 90 can be incorporated into the cellular core body 20 such that the stratum is disposed along one or both of the first edge 22 or the second edge 24 of the cells walls 40. Thus, it is understood the stratum 90 can follow the profile of the edge and be planar, curvilinear or faceted.

The reinforcing stratum 90 can be of a thickness between approximately the dimension of the minimum wall thickness 50 of the cell walls 40 to approximately less than one half of the height of the core body 20.

The reinforcing stratum 90 can be formed of a thermoplastic polymer material (with or without a reinforcing element, as described above) that is the same as the thermoplastic polymer forming the cell walls 40. Thus, an integral cellular body 10 and reinforcing stratum 90 can be achieved in a single-shot, single-step injection molding process.

Alternatively, the reinforcing stratum 90 can be comprised of a thermoplastic polymer material that is different from, but chemically compatible with, the thermoplastic polymer comprising the cell walls 40. For example, in the Polyolefin range, Polyethylene can be combined with Polypropylene, and for example in the Polycarbonate range, Polycarbonate can be combined with PETG, and Polyamide 6 can be combined with Polyamide 12. The use of different materials can be accomplished in a two-shot or over-molding, single-step injection molding process.

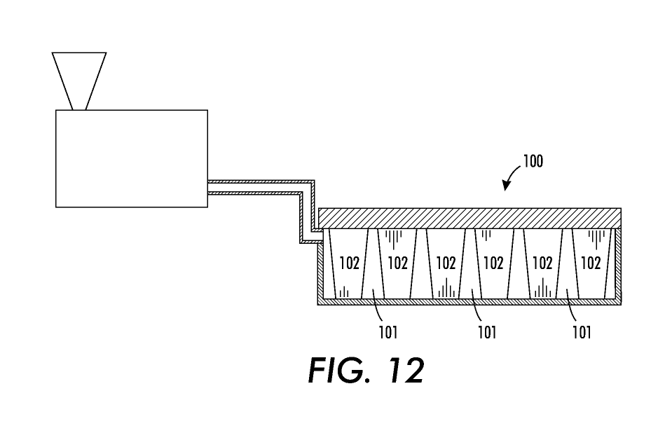

As seen in FIG. 12, an injection molding method for producing the cellular core 10 involves filling a mold 100 with a molten resin at high pressure, wherein the mold includes a plurality of core pins 102 for defining the cell walls 40, and hence cells 25 are provided. The mold 100 can be filled using an injection molding machine and the cellular core is formed as an injection molded part. According to the above described structures, it is possible to easily manufacture the cellular core 10 at low cost by injection molding.

Generally, the mold 100 includes of a mold cavity 101 and a two-dimensional array of parallel pins 102 extending into the mold cavity. The pins 102 are separated from each other in a predetermined manner, thereby defining the cell walls 40 and hence the reinforcing pillars 60, the minimum wall thickness sections 50 within the cellular core 10. As the minimum wall thickness section 50 can have a dimension of less than 1.5 mm, the separation between pins 102 in the mold 100 will be less than 1.5 mm. Further, as the minimum wall thickness section 50 can have a dimension of less than 1.0 mm, the separation between pins 102 in the mold 100 will be less than 1.0 mm, and in a further configuration as the minimum wall thickness section can have a dimension of less than 0.5 mm, the separation between core pins in the mold will be less than 0.5 mm.

As the cell walls 40 can define the cells 25 to have any of a variety of cross sections, and the pins 102 define the cross section of the cells, the pins can have a cross section that is polygonal, circular, faceted or curvilinear to form the corresponding cell structure 25 of the same shape and size.

Each pin 102 produces a corresponding cell 25 within the core body 20. The pins 102 can have dimensions between approximately 3 mm and 30 mm in diameter (for circular or oval pins) or diagonally (for polygonal pins) and between 5 mm and 200 mm in length (thereby defining a minimum height of the cells 25, as a stratum 90 may add additional height to the overall core body 10).

The core pins 102 can be all of the same size, resulting in a cellular core 10 having a uniform density throughout the core body 20. The pins 102 can be of various sizes, resulting in a cellular core 10 having a non-uniform density throughout the core body 20. Alternatively, the pins 102 can be non-uniformly distributed across the mold, thereby providing a resulting cellular core 10 having a non-uniform density.

Further, the spacing of the pins 102 allows the formation of the sizing and location of the reinforcing pillars 60. For example, if larger reinforcing pillars 60 are desired, the pins 102 defining the reinforcing pillars 60 are shaped and placed farther from each adjacent pin 102 to increase the distance between the centroids 62 of the reinforcing pillars 60 and the edge of the reinforcing pillars 60 to create a larger cross sectional area of the reinforcing pillars 60. If smaller reinforcing pillars 60 are desired, the pins 102 defining the reinforcing pillars are shaped and placed closer to each adjacent pin 102 to reduce the distance between the centroids 62 of the reinforcing pillars 60 and the edge of the reinforcing pillars 60 to create a smaller cross sectional area of the reinforcing pillars 60.

The mold cavity 101 is filled by an injection molding machine, with the set of core pins 102 extending into the mold cavity, with molten polymer from the machine flowing along at least one resin flow path into the mold cavity. The flow path can include a manifold such as a hot runner manifold to provide a number of drops into the mold cavity.

Upon sufficient cooling, and hence hardening of the injected material, the resulting cellular core 10 is removed from the mold cavity 101.

Removal of the core body 20 from the mold cavity 101 can be facilitated by the use of a release agent sprayed onto the core pins 102 and the mold prior to molding; and/or by introducing a tapered draft to each side of the core pins 102 (this taper may be between 0.25° and 5°); and or by injecting gas between the core pins 102 and the solidified polymer filling the cavity.

As previously set forth, the reinforcement elements 80 (e.g. glass fibers, carbon fibers, aramid fibers, natural fibers, or glass spheres) can be introduced into the inter-cell reinforcement volumes for even further strengthening the cellular core 10. The inclusion of the reinforcement elements 80 is accomplished by incorporating the reinforcing elements into the polymer material prior to injection into the mold cavity 101. Such polymers containing the desired reinforcing elements are currently readily available through polymer manufacturers, compounders, and distributors, such as provided by Sabic, Dow Chemical, DuPont, Bayer and BASF. Commercially available compounding can be provided by entities such as RTP Company, Winona, Minn.

The reinforcing elements 80 can be in a uniform or a non-uniform distribution within the cellular core 10 between the relatively larger portions of the cellular core defined by the reinforcing pillars 60 and the minimum wall thickness sections 50. The distribution of the reinforcing elements 80 within the cellular core 10 is at least partly determined by the relative dimensions of the size of the reinforcing elements and the cellular dimensions of minimum wall thickness sections 50 and the reinforcing pillars 60.

Given the minimum wall thickness sections 50 are of relatively smaller dimensions than the reinforcing pillars 60, the reinforcing elements 80 will tend to be distributed in a relatively lower density in the relatively thin minimum thickness wall sections and higher density in the relatively large reinforcing pillars.

The desired distribution pattern of the reinforcing elements 80 within the cellular core 10 can also be achieved by selecting reinforcing elements of such dimensions that either inhibit or promote the distribution of the reinforcing elements throughout the core body during the injection molding process. It has been found that reinforcing elements 80, such as fibers, tend to move towards the areas of the cellular core 10 formed by flow having the least resistance. Thus, the reinforcing elements tend to concentrate in the reinforcing pillars 60.

Referring again to FIG. 7, to achieve a more uniform distribution of the reinforcing elements 80 throughout the cellular core 10, the difference in dimensional size between the reinforcing pillars 60 and the minimal wall thickness sections 50 should be minimized at the same time that the dimensional size of the reinforcing elements 80 should be minimized.

Referring again to FIG. 8, to achieve a more non-uniform distribution of the reinforcing elements 80 throughout the cellular core 10, the difference between the dimensional size of the reinforcing pillars 60 and the minimum wall thickness sections 50 should be maximized, at the same that the difference between the dimensional size of the reinforcing elements 80 and the minimum wall thickness sections 50 should be minimized. This non-uniform distribution can achieve a range of distribution patterns of the reinforcing elements 80 within the cellular core 10 ranging from one of an almost uniform pattern to a pattern in which nearly all (i.e., greater than 90%) of the reinforcing elements are within the reinforcing pillars 60 and less than 10% of the reinforcing elements are within the minimal wall thickness sections.

The cellular core 10 with an integral stratum 90 for reinforcement of the core can be incorporated at the same time the cellular core is injection molded. The stratum 90 can partially or completely occlude each of the cells 25 within the core 10. This can be achieved in several ways as follows:

First, referring to FIG. 11, to create a reinforcing stratum 90 that is disposed along a first edge 22 of the cell walls 40, the core pins 102 are shorter than the depth of the mold cavity 101 that receives the core pins leaving a gap between the surface of the cavity which forms the outer surface of the core body 20 and the end of the pin that is not fixed to the plate within the mold. The depth of this gap is equal to the desired thickness of the resulting stratum 90 to exist on the outer edge of the molded part. It is understood this gap and the resulting stratum 90 could be of a uniform or non-uniform thickness over the surface of core body 20. The uniform stratum thickness can be obtained by maintaining a uniform length to the pins 102, and the non-uniform stratum thickness can be obtained by varying the length of the pins for each location across the first edge of the cellular core 10. As the gap can be filled with polymer at the same time and in the same process as the cell walls 40 are filled, the stratum 90 is formed, and specifically integrally formed with the cell walls. The edge 22 or 24 of the cellular core 10 and the reinforcing stratum 90 can have the flat planar surface or can vary with topographical high and low points or any surface shape desired.

Second, referring to FIGS. 9 and 10, to create a reinforcing stratum 90 that is intermediate to the first edge 22 and the second edge 24 of the cell walls 40, the mold 100 has two sets of pins 102 that form the cells 25 of the cellular core 10. One set of pins is affixed to one side of the mold cavity and the other set of pins is affixed to the opposite side of the mold, with the parting line of the mold located between the two sets of pins. When the mold 100 is in a closed position, the ends of the opposing pins 102 may align with each other with a gap between each set of opposing pins. The depth of this gap would be equal to the desired thickness of the resulting reinforcing stratum 90 to exist within the molded cellular core 10. This gap and the resulting stratum 90 could be of a uniform or non-uniform thickness throughout all or part of the core body 20. This would be achieved by maintaining a uniform gap between aligned pins 102 or varying the gap between aligned pins. The gap would be filled with polymer at the same time and in the same process as the cell walls 40 are filled. It is understood the core pins 102 of the respective mold halves can be aligned coaxially, or can be axially offset. Further, the core pins 102 of the respective mold halves can be of different sizes.

Third, referring to FIG. 9, to create a reinforcing stratum 90 that is transverse to the cell walls 40, the core pins 102 within each set of pins, as affixed to each side of the mold cavity, are of a uniform length. The gap is then filled with polymer at the same time and in the same process as the cells walls 40 are formed.

Fourth, referring to FIG. 10, to create a reinforcing stratum 90 that is inclined relative to the cell walls 40, the core pins 102 within each set of pins, affixed to each side of the mold cavity, are of different lengths. The variation in the length of pin is matched by an equal and opposite variation in the opposing pin that aligns with the first pin when the mold is closed. For example if the variation in the length of the first pin in the first set of pins is +1 mm then the variation in the length of the corresponding pin in the second set of pins is −1 mm so that when the mold 100 closes, the gaps between aligned pins remains the same as the gap formed by the adjacent pins. The gap would be filled with polymer at the same time and in the same process as the cell walls 40 are filled.

In all cases of the intermediate reinforcing stratum 90, the gap is filled with the same polymeric material as the cell walls 40. In the case of the reinforcing stratum 90 being disposed along the first edge 22 or the second edge 24 of the core body 20, the gap creating the stratum may be filled with the same polymeric material as the cell walls or with a different polymeric material that is chemically compatible with the polymeric material comprising the cell walls. When desired, producing a stratum 90 that is comprised of a different and chemically compatible polymeric material can be achieved through a standard two-shot or over-molding, single-step injection molding process.

The cellular core 10 is thus an integral, unitary structure either of a single compound or commonly molded compounds. That is, the cellular core 10 is not a combination of previously and separately formed constituents, which are subsequently joined, but rather the present cellular core 10 has either a homogeneous distribution of a polymer compound or an integral union of different polymers being commonly molded. Further, as the cellular core 10 is formed by injection molding, the core includes a parting line. It is understood the term parting line is often used in place of the term parting surface. The parting line typically appears as a faint vector, a witness of two parting surfaces contacting each other when the mold is closed, upon the face of the cellular core 10.

For those constructions of the cellular core 10 incorporating the separate, preformed component 66, the separate component is disposed within the mold cavity 101 prior to introduction of the polymer. The mold is then filled with the polymer and the separate component 66 is thus at least partially embedded within the resulting cellular core 10, specifically with a reinforcing pillar 60.

While the invention has been described in connection with preferred embodiments, the description is not intended to limit the scope of the invention to the particular forms set forth, but on the contrary, it is intended to cover such alternatives, modifications, and equivalents as may be included within the spirit and scope of the invention as indicated by the language of the appended claims.

1. A cellular core assembly, comprising:
(a) a polymeric core body having a plurality of cells defined by cell walls, the cell walls having a plurality of minimum wall thickness sections and reinforcing pillars, each reinforcing pillar bounded by at least three minimum wall thickness sections; and
(b) a minimum wall thickness section being less than 1.5 mm and a centroid of the reinforcing pillar spaced from the nearest cell by a distance greater than the minimum wall thickness.

2. The cellular core assembly of claim 1, wherein the minimum wall thickness sections are less than 0.5 mm.

3. The cellular core assembly of claim 1, further comprising a component of a different material at least partially embedded within the reinforcing pillar.

4. The cellular core assembly of claim 1, wherein the cell walls define an integral peripheral wall extending about the core body, the peripheral wall having a thickness greater than the minimum wall thickness section.

5. The cellular core assembly of claim 1, wherein the cell walls define an integral peripheral wall extending about the core body, the peripheral wall defining a substantially planar outer surface.

6. The cellular core assembly of claim 1, wherein the core body has a substantially uniform density.

7. The cellular core assembly of claim 1, wherein the core body has a non-uniform density.

8. A cellular core assembly, comprising:
(a) a polymeric core body having a plurality of cells defined by cell walls, the cell walls having minimum wall thickness sections and reinforcing pillars, each reinforcing pillar bounded by at least three minimum wall thickness sections; and
(b) a plurality of reinforcing elements within the core body.

9. The cellular core assembly of claim 8, wherein the reinforcing elements are non-uniformly distributed throughout the core body.

10. The cellular core assembly of claim 8, wherein the reinforcing elements are substantially uniformly distributed throughout the core body.

11. The cellular core assembly of claim 8, wherein a distribution of the reinforcing elements is greater in the reinforcing pillars than the minimum wall thickness sections.

12. The cellular core assembly of claim 8, wherein the minimum wall thickness sections is less than 1.5 mm.

13. A cellular core assembly, comprising:
(a) a polymeric core body having (i) a plurality of cells defined by cell walls, the cell walls having minimum wall thickness sections and reinforcing pillars, each reinforcing pillar bounded by at least three minimum wall thickness sections; and (ii) a stratum occluding the plurality of cells, the stratum being integral with the cell walls.

14. The cellular core assembly of claim 13, wherein the stratum is transverse to the cell walls.

15. The cellular core assembly of claim 13, wherein the stratum is inclined relative to the cell walls.

16. The cellular core assembly of claim 13, wherein the stratum is disposed along a first edge of the cell walls.

17. The cellular core assembly of claim 13, wherein the stratum is intermediate a first edge and a second edge of the cell walls.

18. The cellular core assembly of claim 13, wherein the cell walls are formed of a first material and the stratum is formed of a different second material.

19. The cellular core assembly of claim 13, wherein the cell walls and the stratum are formed of the same first material.

20. The cellular core assembly of claim 13, wherein the minimum wall thickness sections are less than 1.5 mm.
